(19) United States
(12) Patent Application Publication
(10) Pub. No.: US 2015/0107869 A1
(43) Pub. Date: Apr. 23, 2015

(54) BLOCK FOR ELECTRICAL BONDING AND GROUNDING

(71) Applicant: SOONTAI TECH CO., LTD., Tainan City (TW)

(72) Inventors: CHIH-PIN YAO, TAINAN CITY (TW); CHUN-YI LI, TAINAN CITY (TW); WEN-LIANG TU, TAINAN CITY (TW); CHIH-CHUNG YANG, TAINAN CITY (TW)

(21) Appl. No.: 14/521,592

(22) Filed: Oct. 23, 2014

(30) Foreign Application Priority Data
Oct. 23, 2013 (TW) 102219750
Nov. 21, 2013 (TW) 102221821

(51) Int. Cl. H01R 4/66; H01R 4/28; H01R 4/56

(52) U.S. Cl. CPC H01R 4/66; H01R 4/56; H01R 4/28
USPC 174/51

(57) ABSTRACT

A block for electrical bonding and grounding made by punching and bending a metal sheet is provided. The block for electrical bonding and grounding has a fixing section formed on its bottom end and a connecting section formed uprightly on one side of the fixing section. The fixing section has a ground portion formed thereon by bending a cut portion into a U-shape portion, and the ground portion has a ground wire passage for passing through of a ground wire. The ground wire passage has a shrunk neck portion provided for limiting the ground wire. A threaded hole is provided correspondingly such that a fastening screw can be threaded through the threaded hole to clamp the ground wire securely in position. The overall manufacturing process is easier, more convenient and quicker so that the overall cost is lowered.

### BACKGROUND OF INVENTION

1. Field of the Invention

The present invention relates to a block for electrical bonding and grounding, more particularly to a block for electrical bonding and grounding the overall manufacturing process of which is easier, more convenient and quicker so that the overall cost is lowered, and the overall implementing performance thereof is increased.

2. Brief Description of Prior Art

The MoCA (Multimedia over Coax Alliance) networking technology is a technology alliance commonly formed on January 2004 by a number of cable TV operators, satellite TV industries, network equipment vendors, which is mainly to actively promote the connection of TV, digital multimedia devices by home coaxial cable so as to transfer multimedia files and application service, the purpose of which is to integrate telephone, network, cable TV (CATV), Satellite Master Antenna Systems (SMATV) and wireless LAN (WLAN) etc . . . through the network technology of the MoCA into the coaxial cable, so that people can enjoy more convenience in their lives. After entering into home client side, a variety of signals transferred through the coaxial cable are subjected to, via communication components, various corresponding signal processing such as filtering, amplification, decoding, modulation etc . . . , so that the signals can be performed with filtering, amplification, decoding, modulation etc . . . , and required signals are thus obtained.

The coaxial cable is mainly led to each client end by a double-head connector which also has to be disposed on a grounding device simultaneously. The grounding action of the grounding device can provide a protection to instant high voltage or high current so that coaxial cable, TV or radio receiver and the other electronic devices can be prevented from damage by instantaneous voltage and current. The electrical bonding and grounding block for coaxial cable is described in prior disclosures such as U.S. Pat. No. 6,877,996 B1, U.S. Pat. No. 7,198,495 B1, or US D487427 S. However, these electrical bonding and grounding bloc is very complex in structure, resulting in high production costs and inconvenience in assembly at user side.

### SUMMARY OF THE INVENTION

The main object of the present invention is to provide a block for electrical bonding and grounding formed by punching and bending a metal sheet, the overall manufacturing process of which is easier, more convenient and quicker so that the overall cost is lowered, and the overall implementing performance thereof is increased.

The above object and its performance of the block for electrical bonding and grounding of the present invention are achieved by the following technical means.

A block for electrical bonding and grounding made by punching and bending a metal sheet is provided. The block for electrical bonding and grounding has a fixing section formed on its bottom end and a connecting section formed uprightly on one side of the fixing section. The fixing section has a ground portion formed thereon by bending a cut portion into a U-shape portion, and the ground portion has a ground wire passage for passing through of a ground wire. The ground wire passage has a shrunk neck portion provided for limiting the ground wire. A threaded hole is provided correspondingly such that a fastening screw can be threaded through the threaded hole to clamp the ground wire securely in position. The overall manufacturing process is easier, more convenient and quicker so that the overall cost is lowered.

BRIEF DESCRIPTION OF ACCOMPANYING DRAWINGS

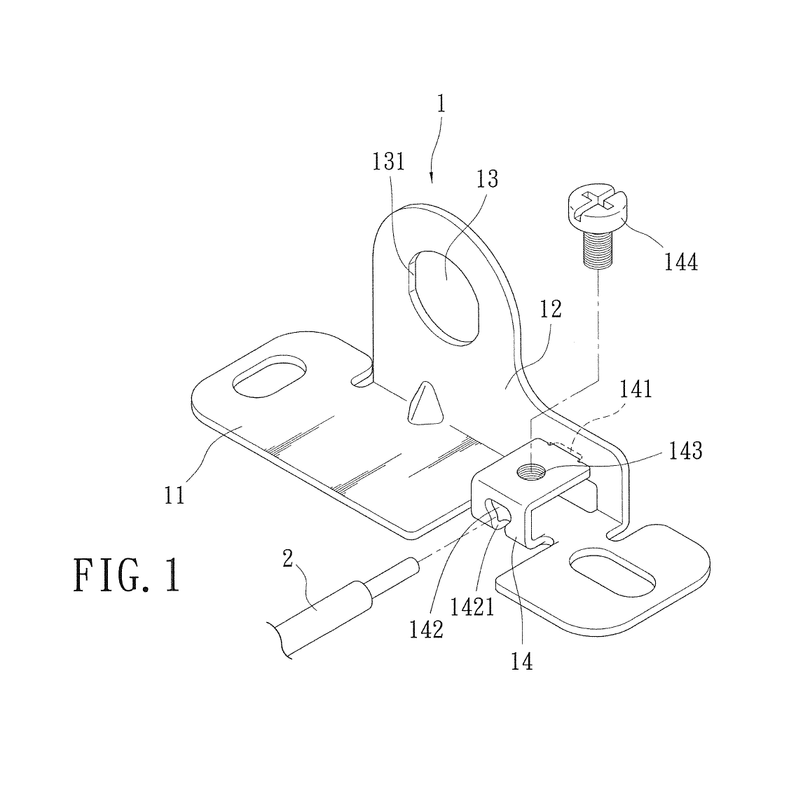

### FIG. 1 is a perspective schematic view of the structure of the present invention;

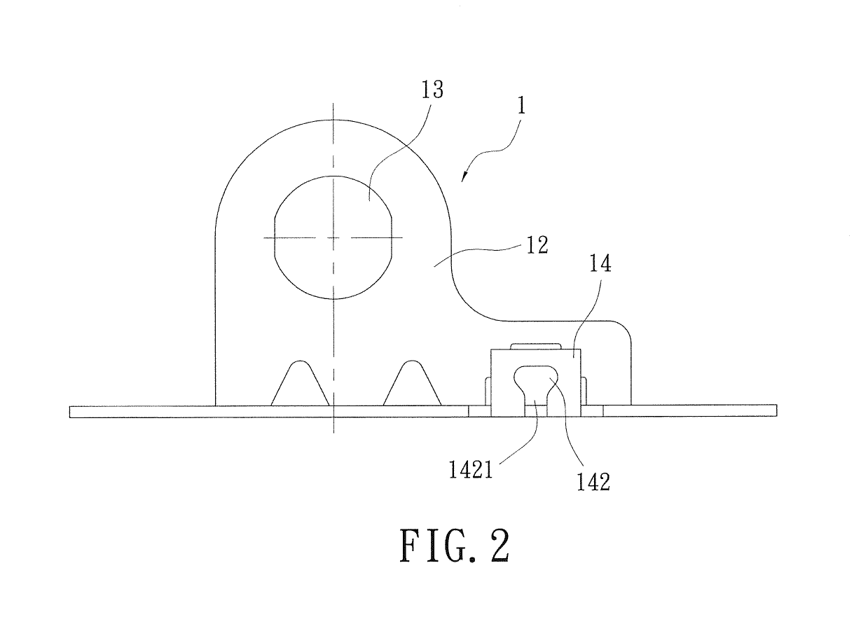

FIG. 2 is a schematic front view of the structure of the present invention;

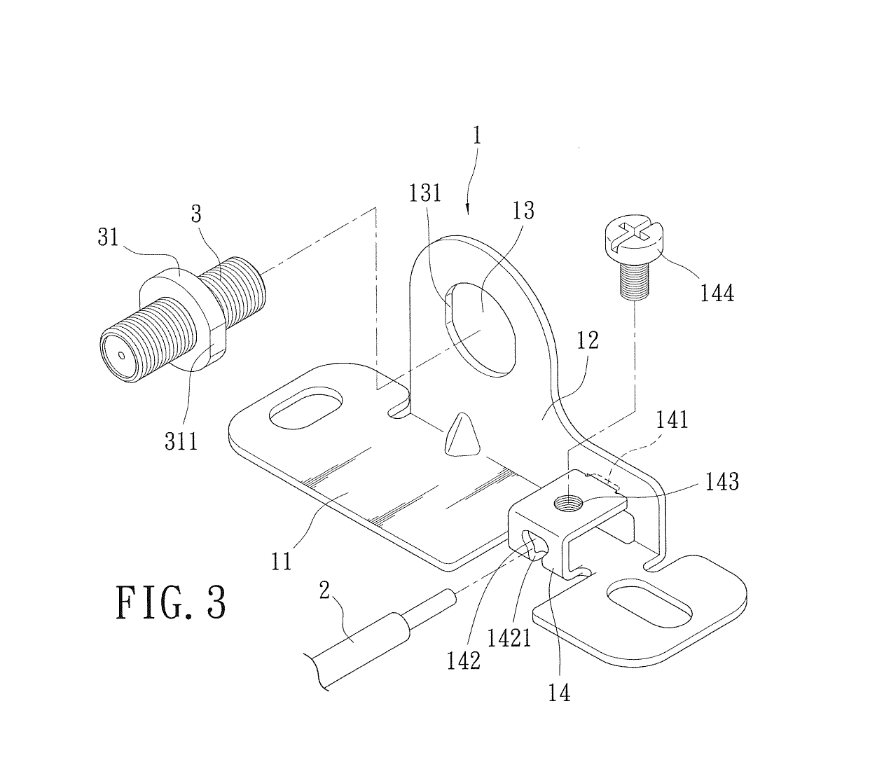

FIG. 3 is a perspective exploded schematic view of the structure of the present invention in a first use state;

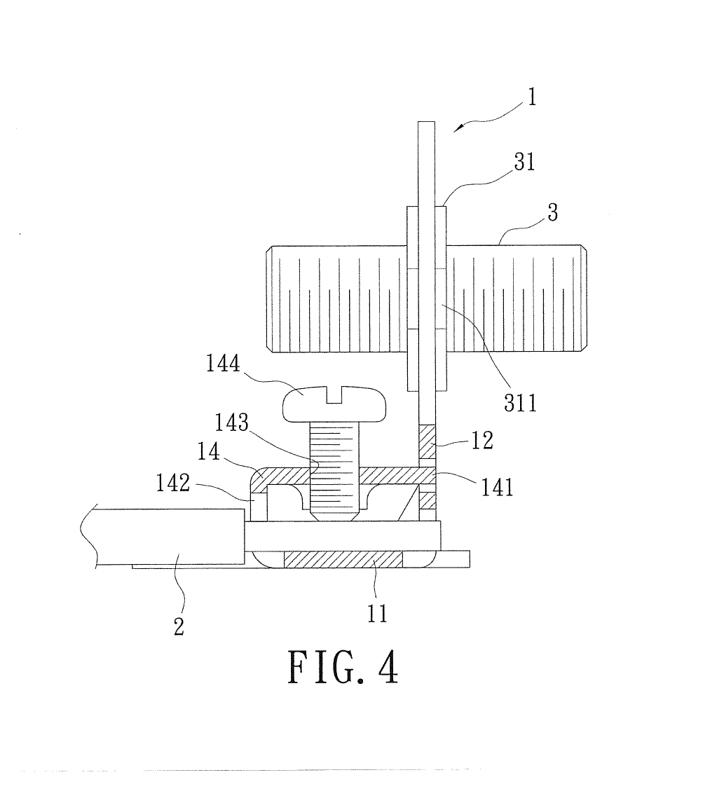

FIG. 4 is a schematic assembly sectional view of the structure of the present invention in the first use state;

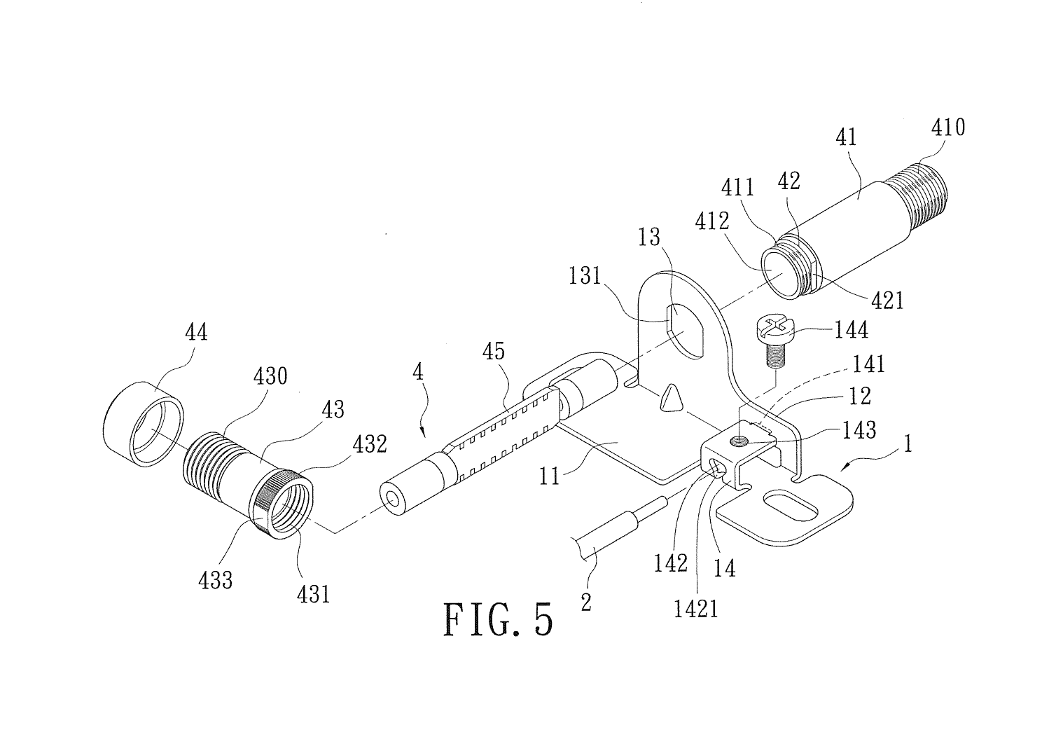

FIG. 5 is a perspective exploded schematic view of the structure of the present invention in a second use state;

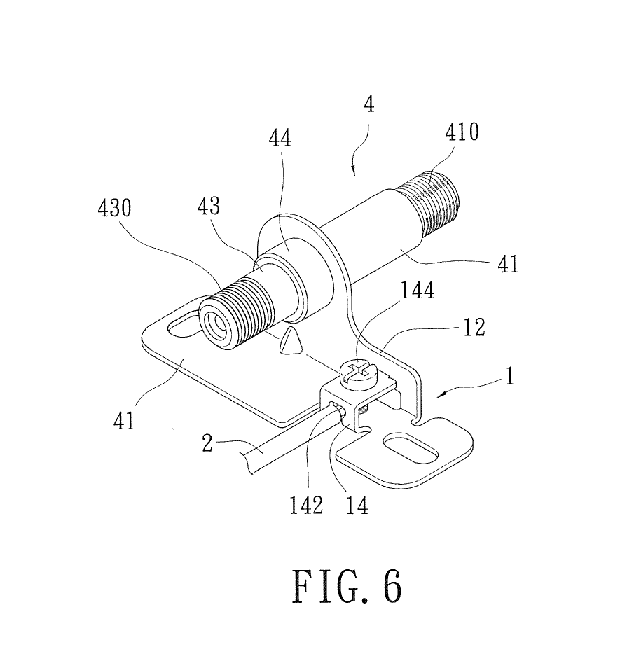

FIG. 6 is a perspective assembly schematic view of the structure of the present invention in the second use state;

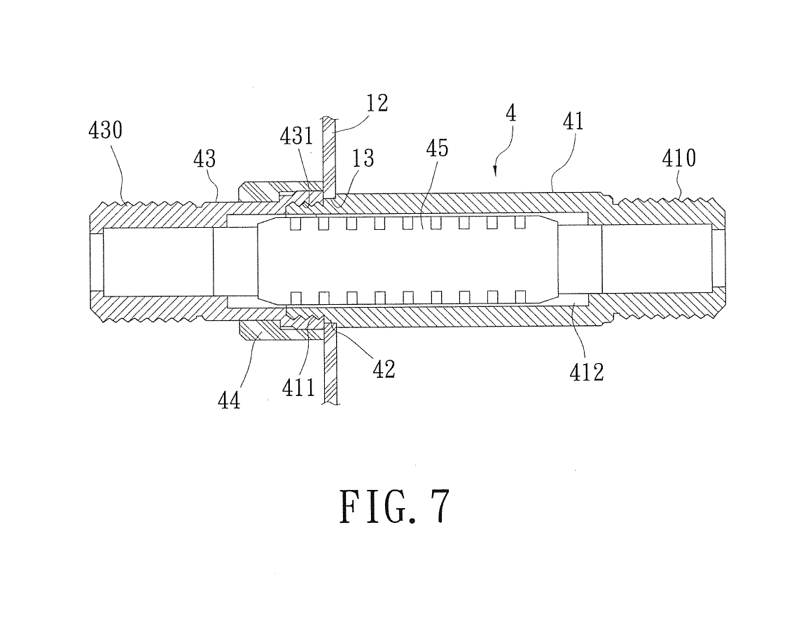

FIG. 7 is an assembly sectional schematic view of the structure of the present invention in the second use state;

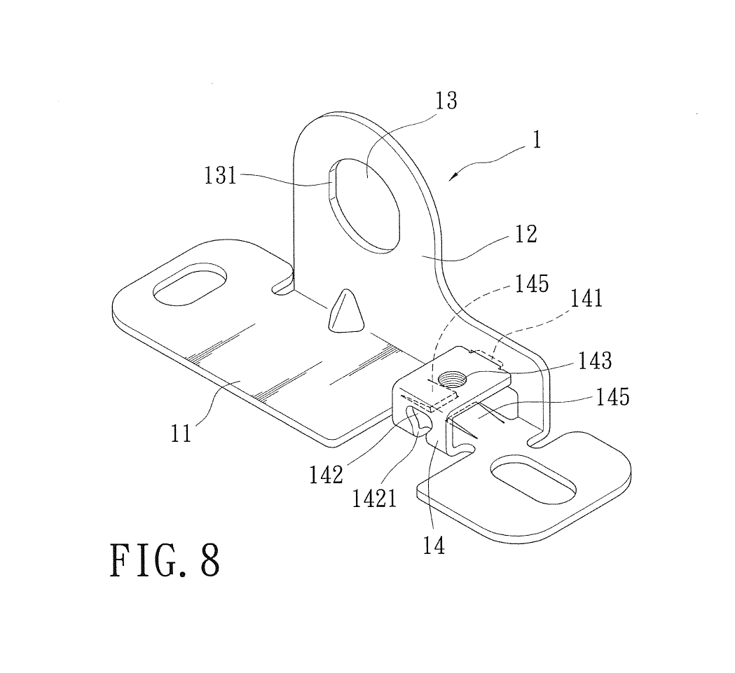

FIG. 8 is a perspective schematic view of the structure of another embodiment of the present invention; and

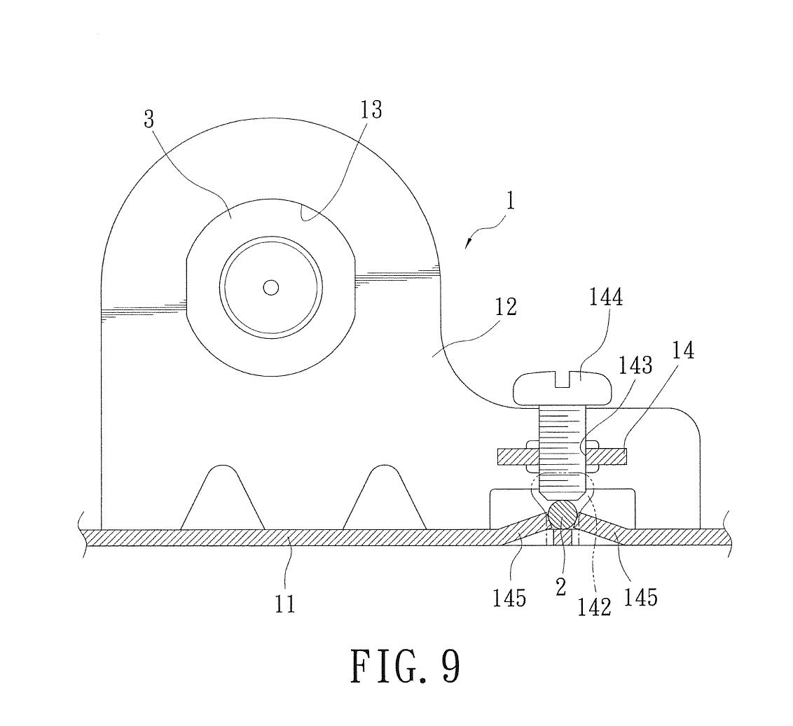

FIG. 9 is an assembly sectional schematic view of the structure of another embodiment of the present invention.

### DETAILED DESCRIPTION OF PREFERRED EMBODIMENTS

The objects, the technical contents and the expected effect of the present invention will become more apparent from the detailed description of preferred embodiments in conjunction with the accompanying drawings.

Firstly referring to FIGS. 1 and 2, a block for electrical bonding and grounding (1) of the present invention is formed by punching and bending a metal sheet. T he block for electrical bonding and grounding (1) has a fixing section (11) formed on its bottom end and a connecting section (12) formed uprightly on one side of the fixing section (11). A connecting passage (13) is formed on the connecting section (12), and the connecting passage (13) has at least one flat face (131). The fixing section (11) has a ground portion (14) formed thereon by bending a cut portion into an U-shape portion, and the ground portion (14) has a lug segment (141) formed on its tip, which is engaged into a slot formed on the connecting section (12) for positioning. The ground portion (14) has a ground wire passage (142) for passing through of a ground wire (2). The ground wire passage (142) has a limiting segment (1421) with a shrunk neck portion for limiting the inserted ground wire. A threaded hole (143) is provided corresponding to the ground portion (14) such that a fastening screw (144) can be threaded through the threaded hole (143).

Referring to FIGS. 3 and 4, the assembly operation of the coaxial cable and the ground wire on the block for electrical bonding and grounding having above structure will be described as below. Firstly, the fixing section (11) of the block for electrical bonding and grounding (1) is fixed on a predetermined place. Then, a double-head connector (3), having at least one flat cut-out face (311) corresponding to the at least one flat face (131) of the connecting passage (13) and provided on a flange periphery (31), is assembled on the connecting passage (13), such that the flange periphery (31) of the double-head connector (3) can be fitted snugly in the connecting passage (13). In this manner, the double-head connector (3) is fixed securely in place and is prevented from rotation. Next, the internal and external coaxial cables are connected respectively on the double-head connector (3), and the ground wire (2) is inserted into the ground wire passage (142) provided on the ground portion (14) of the block for electrical bonding and grounding (1). The ground wire (2) can be well positioned in place by the limiting segment (1421) having shrunk neck beneath the ground wire passage (142). Then, the fastening screw (144) is threaded into the threaded hole (143) to clamp the ground wire (2) in position, so as to achieve required grounding.

Further referring to FIG. 5, a second use state of the present invention is shown. In this figure, a communication component (4) is provided correspondingly to the connecting passage (13) of the block for electrical bonding and grounding (1). The communication component (4) has a first housing (41) having a thread joint (410) formed at one end and a step ring portion (42) formed at the other end. At least one flat cut-out face (421) is formed on the outside of the step ring portion (42), and a threaded segment (411) is formed at the front end of the step ring portion (42). Further, the first housing (41) also has a hollow space (412) formed therein for receiving a communication board (45), which can be anyone selected from a filter, a harmonic suppressor, an amplifier. Furthermore, a second housing (43) corresponding to the first housing (41) is also provided, which has a thread joint (430) formed on one end and an internal threaded hole (431) corresponding to the thread segment (411) of the first housing (41). A knurled portion (432) is formed on an outer rim of the second housing (43), and parallel flat portions (433) are formed oppositely on the knurled portion (432). A protection sleeve (44) corresponding to the knurled portion (432) of the second housing (43) is provided, the protection sleeve (44) can be fitted tightly on the knurled portion (432) of the second housing (43).

Referring to FIGS. 6 and 7, the assembly between the communication component (4) and the block for electrical bonding and grounding (1) will be described as below. Firstly, the step ring portion (42) of the first housing (41) is fitted into the connecting passage (13) of the assembly portion (12) with the flat cut-out face (421) of the step ring portion (42) engaged with the flat face (131) within the connecting passage (13), so that the first housing is fixed in the connecting passage (13) without any rotation produced. Then, the communication board (45) is received into the hollow space (412) of the first housing (41) and the second housing (43) is connected with the first housing (41) by the engagement of the internal threaded hole (431) with the thread segment (411) of the first housing (41), so that the communication component (4) is combined integrally with the block for electrical bonding and grounding (1). The parallel flat portions (433) of the second housing (43) are used for engagement with a hand tool for applying torque. After the second housing (43) is combined securely with the first housing (41), the protection sleeve (44) is fitted tightly on the knurled portion (432) of the second housing (43) by punching, so that the communication component (4) is assembled firmly on the block for electrical bonding and grounding (1). After the fixing section (11) of the block for electrical bonding and grounding (1) is fixed on predetermined place, the internal and the external coaxial cables can be connected to the thread joints (430), (410) respectively, and the grounding can be achieved by the ground wire (2) inserted in the ground wire passage (142) of the ground portion (14).

Referring to FIG. 8, another embodiment of the present invention will be described. In the block for electrical bonding and grounding (1) of this embodiment, the bottom end of the ground portion (14) is punched in such a manner that two opposite clamping bodies (145) corresponding to both sides of the ground wire passage (142) are formed. The ground wire (2) inserted into the ground wire passage (142) can be clamped between the two clamping bodies (145) without any displacement produced. Then, a fastening screw (144) can be threaded through the threaded hole (143) to clamp the ground wire (2) in place, so that grounding action can be achieved, as shown in FIG. 9.

Based on foregoing, it is apparent from the structural constitution and implementation of the present invention that the block for electrical bonding and grounding of the present invention is made of metal sheet by punching and bending; the overall manufacturing process is easier, more convenient and quicker and the overall cost is lowered. Therefore, the overall implementing performance thereof is increased.

What is claimed is:

1. A block for electrical bonding and grounding, which is formed by punching and bending a metal sheet, having a fixing section formed on its bottom end and a connecting section formed uprightly on one side of the fixing section; the connecting section has a connecting passage provided thereon and the fixing section has a ground portion formed thereon by bending a cut portion into an U-shape portion;
the ground portion has a ground wire passage for passing through of a ground wire; the ground wire passage has a limiting segment with a shrunk neck portion; a threaded hole is provided correspondingly such that a fastening screw can be threaded through the threaded hole to clamp the ground wire securely.

2. The block for electrical bonding and grounding as claimed in claim 1, wherein a double-head connector is provided to correspond to the connecting passage of the block for electrical bonding and grounding; at least one flat face is formed within the connecting passage which is engaged with at least one flat cut-out face formed on a flange periphery of the double-head connector.

3. The block for electrical bonding and grounding as claimed in claim 1, wherein a communication component is provided correspondingly to the connecting passage of the block for electrical bonding and grounding; at least one flat face is formed within the connecting passage; the communication component has a first housing having a step ring portion formed at the one end, and the step ring portion has at least one flat cut-out face formed on the outside thereof and a threaded segment formed at the front end of the step ring portion;
the first housing also has a hollow space formed therein for receiving a communication board; a second housing corresponding to the first housing is also provided, the second housing has an internal threaded hole corresponding to the thread segment of the first housing so that the internal threaded hole of the second housing can be engaged with the thread segment of the first housing.

4. The block for electrical bonding and grounding as claimed in claim 3, wherein parallel flat portions are formed oppositely on an outer rim of the second housing.

5. The block for electrical bonding and grounding as claimed in claim 3, wherein a knurled portion is formed on the outer rim of the second housing, and a protection sleeve corresponding to the knurled portion is provided, the protection sleeve is fitted tightly on the knurled portion.

6. The block for electrical bonding and grounding as claimed in claim 3, wherein the communication board is anyone selected from a filter, a harmonic suppressor, and an amplifier.

7. The block for electrical bonding and grounding as claimed in claim 1, wherein the ground portion has a lug segment which is engaged into a slot formed on the connecting section for positioning.

8. The block for electrical bonding and grounding as claimed in claim 1, wherein the bottom end of the ground portion of the block for electrical bonding and grounding is punched in such a manner that two opposite clamping bodies corresponding to both sides of the ground wire passage are formed, so that the ground wire passing through the connecting passage can be clamped between the two clamping bodies.
